(19) United States
(12) Patent Application Publication
(10) Pub. No.: US 2026/0131565 A1
(43) Pub. Date: May 14, 2026

(54) CORRUGATED CARDBOARD PRODUCTION APPARATUSES

(71) Applicant: QUANTUMCORRUGATED S.r.l., Milano (MI) (IT)

(72) Inventor: Marco MARRACCINI, Capannori (LU) (IT)

(21) Appl. No.: 19/118,001

(22) PCT Filed: Oct. 9, 2023
(86) PCT No.: PCT/IB2023/060101

§ 371 Date: Apr. 3, 2025

(30) Foreign Application Priority Data
Oct. 10, 2022 (IT) 102022000020817

(51) Int. Cl. B32B 38/18; B32B 29/00; B32B 29/08; B32B 37/20

(52) U.S. Cl. CPC B32B 38/18; B32B 29/005; B32B 29/08; B32B 37/20; B32B 2250/02; B32B 2250/26

(57) ABSTRACT

A corrugated cardboard production apparatus may include: a coupling group configured to associate a strip of canneté and a continuous strip of flat paper to form single-wave corrugated cardboard; a first reel to store the canneté; a second reel to store the flat paper; first rollers to support the first reel; and second rollers to support the second reel. A method for production of cardboard “on demand” may include: providing a coupling group, a flat paper reel, a canneté reel, and a system for supporting the reels that includes a pair of support rollers; starting an unwinding of a strip of flat paper and a strip of canneté from respective reels; transferring the strips, unwound from the respective reels, to the coupling group; coupling together the strips so as to form a single-wave corrugated cardboard; and interrupting the unwinding of the strips from the respective reels.

The present invention relates to the sector of plants and apparatus for the production of corrugated cardboard.

The corrugated cardboard production plants known in the art comprise at least one corrugation unit which is supplied with continuous flat paper webs. Each corrugation unit comprises a corrugator, referred to as a “single facer”, particularly suitable for creating corrugations on one of the continuous flat paper webs and combining the corrugated web with a continuous flat paper web, referred to as a “facing”, thus forming a continuous composite cardboard sheet, referred to as a “canneté”.

The corrugated cardboard production plants furthermore comprise a plurality of processing stations which are arranged in sequence and receive the canneté formed by the corrugation unit and are able to finalize the production of the corrugated cardboard. For example, plants which comprise a coupling unit which forms a corrugated cardboard by combining, for example gluing together, one or more cannetés and an additional continuous flat paper web, referred to as a “second facing”, are known.

In this sector there is an increasingly greater need for the production of cardboard with predetermined dimensions so as to be able to produce containers, for example boxes, with a predetermined size. Usually the dimensions of the cardboard are chosen depending on the dimensions of the box once formed, which are in turn chosen depending on the contents which will be inserted inside it. This type of production is referred to as production “on demand”.

The creation of containers with predetermined dimensions is usually performed by specific machines, also referred to as packaging or packing machines. The cardboard is introduced into a packaging machine which folds parts of the cardboard so as to create a container or a box. In some cases, the machines also perform the positioning of the product inside the box.

It is not possible to combine a corrugated carboard production plant of the known type with a packaging machine.

The corrugated cardboard production plants of the known type in fact have a series of drawbacks as regards the production of cardboard with different dimensions and/or predetermined characteristics. For example, these plants work with reels of flat paper with large dimensions. Furthermore, the plants of the known type work at extremely high processing speeds which are able to produce as much as 400 metres of cardboard per minute. In such conditions, interrupting the production in order to replace a reel and change the type of flat paper or modify the cutting or creasing dimensions of the cardboard being output results in an excessively high cost for production of the cardboard or even the risk of deterioration of the plant itself. Finally, the plants of the known type require a plurality of additional machines, such as glue preparation machines, steams generators, etc., which result in the plant being overly large and complex to manage.

Solutions which are able to overcome these problems have therefore been studied.

One of the most common solutions is that of supplying a packaging machine with a strip of single-wave corrugated cardboard having a predefined width and length. This strip of single-wave corrugated cardboard is stored, for the purposes of easier storage and removal, folded up onto itself inside a container. This type of single-wave cardboard is referred to as being of the “fanfold” type, in a similar manner to the continuous sheets of paper used in dot-matrix printers, which are also stored folded-up inside a container.

This type of solution has, however, a major drawback: the high cost of the raw material. The production and transport of fanfold cardboard is extremely costly.

Furthermore, fanfold cardboard has an obvious fold, or crease, in the zone where the cardboard is folded for storage thereof. This results in the risk of producing boxes with a fold in the cardboard on one of its sides or the need to discard that portion of carboard during the manufacture of the box. This results in an obvious increase in production costs.

Another solution of the known type which overcomes the problem of fanfold cardboard is that of supplying the packaging machines with single sheets of single-wave and preferably large-size cardboard. In this way, it is possible to cut the cardboard so as to produce a box according to any required size, provided that it is smaller than the dimensions of the cardboard sheet itself.

Although the cost of producing single sheets of cardboard is less than that of producing fanfold cardboard, this solution also has a major drawback: that of the waste material. Since the cardboard sheet has large dimensions often the boxes produced use only part of that sheet and it is not always possible to use a single sheet in order to produce several boxes, if the overall size of the surface of the boxes does not correspond to the size of the surface of the cardboard sheet.

For this reason there has arisen the need to manage to produce sheets of single-wave cardboard with predetermined dimensions chosen depending on the container or box to be produced, while keeping production costs low and eliminating as far as possible the amount of waste material.

The general object of the present invention is therefore that of finding a solution to this need.

In view of this object, the Proprietor has thought to provide, according to the invention, a corrugated cardboard production apparatus which comprises:
a support structure;
a coupling group suitable for composing a single-wave corrugated cardboard by associating together a strip of canneté and a continuous strip of flat paper; and
a flat paper store and a canneté store; characterized in that the flat paper store and the canneté store are reels, the apparatus also comprising a support system for the reels comprising a pair of support rollers.

The dependent claims define preferred and/or particularly advantageous features of the invention.

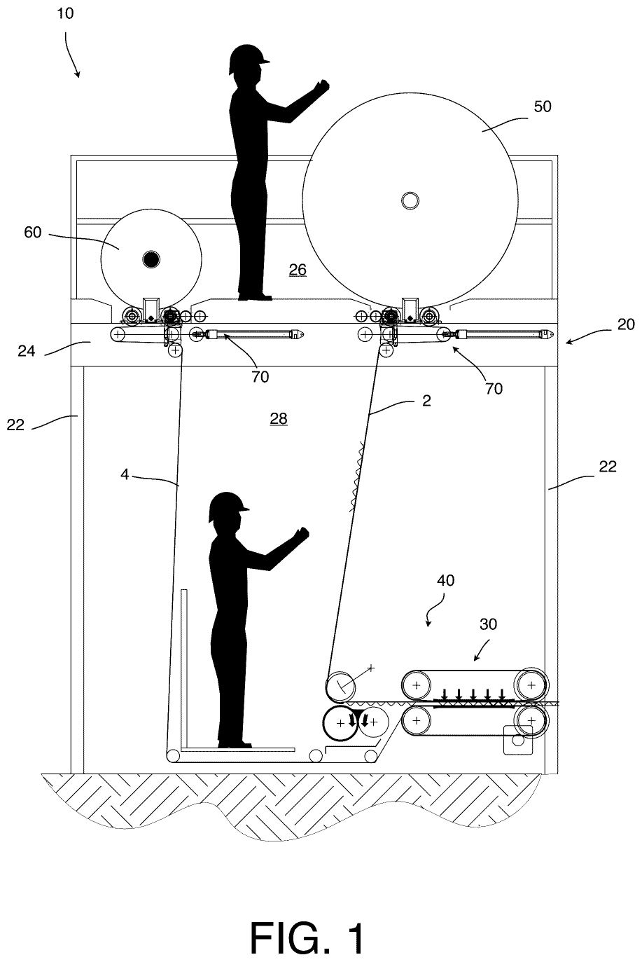

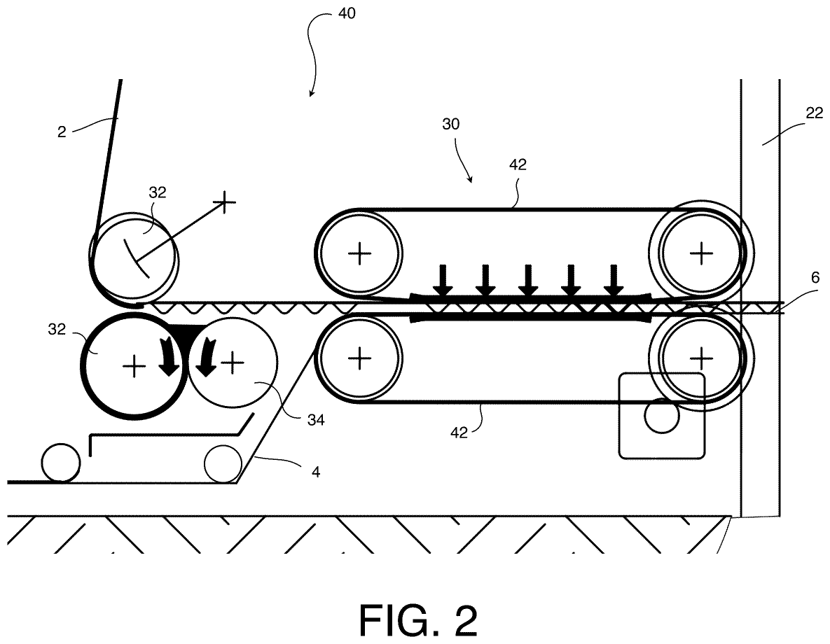

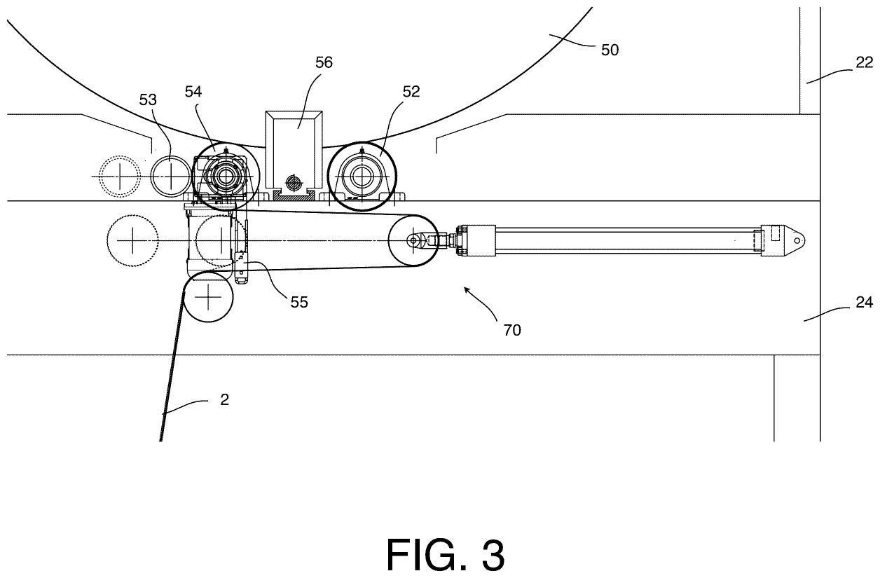

Further characteristic features and advantages of the present invention will emerge more clearly from the following description, provided solely by way of example with reference to the attached drawings, in which:
FIG. 1 is a schematic side view of a corrugated cardboard production apparatus according to the present invention;
FIG. 2 is a detailed, schematic, side view of a coupling group;
FIG. 3 is a detailed, schematic, side view of the system for supporting a reel according to FIG. 1;

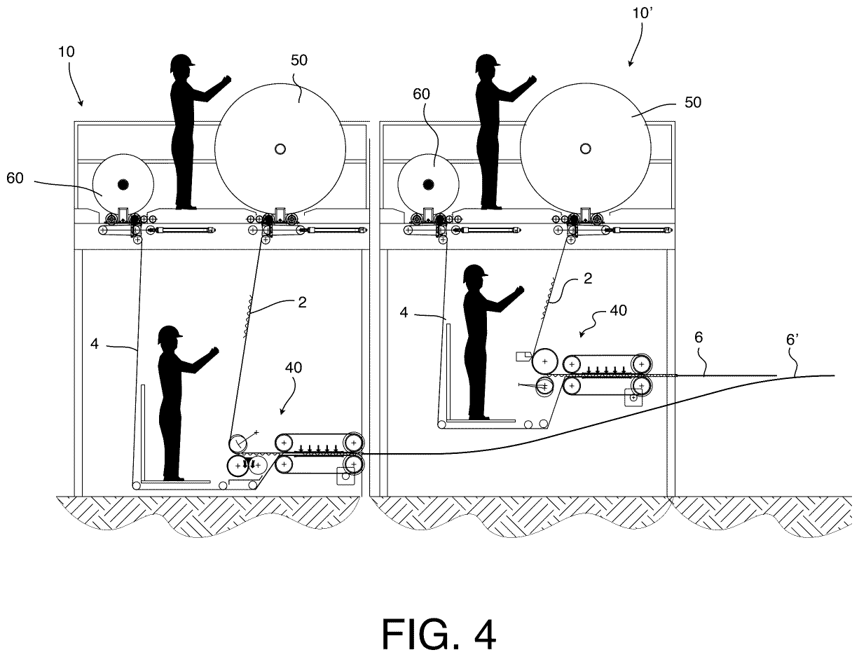

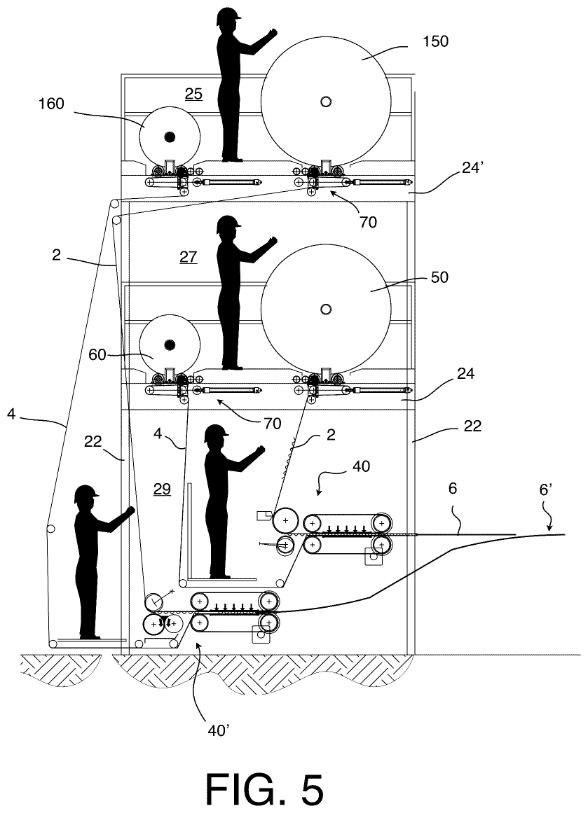

FIG. 4 is a schematic side view of another embodiment of a corrugated cardboard production apparatus according to the present invention; and
FIG. 5 is a schematic side view of a further embodiment of a corrugated cardboard production apparatus according to the present invention.

It is understood that elements or characteristics of one embodiment may be conveniently incorporated in other embodiments without further clarifications.

Reference will now be made in detail to the various embodiments of the invention, one or more examples of which are shown in the attached figures. Each example is provided merely by way of illustration of the invention and is understood as not being a limitation thereof. For example, the technical characteristics shown or described since they form part of one embodiment may be adopted in, or associated with, other embodiments in order to produce a further embodiment. It is understood that the present invention will be inclusive of these modifications and variants.

In a first embodiment of the present invention, a corrugated cardboard production apparatus 10 comprises a support structure, for example, but not exclusively, a support frame 20. In the embodiment shown in FIG. 1, the support frame 20 extends vertically and comprises at least one pair of lateral uprights 22 and a horizontal surface 24 connected to the lateral uprights 22. The frame shown in FIG. 1 defines two operating areas, i.e. an upper area 26 arranged above a second lower operating area 28.

Obviously it is possible to envisage two operating areas 26, 28 which are arranged with respect to each other differently from that described and illustrated here, for example arranged side-by-side. Alternatively it is also possible to envisage two operating areas also without the presence of a horizontal surface 24.

According to possible variants of the present invention, the support frame 20 may also comprise upper and/or lateral covering walls so that the two operating areas 26, 28 form closed compartments.

The corrugated cardboard production apparatus 10 also comprises a coupling group 40 suitable for composing a single-wave corrugated cardboard by associating together a strip of canneté 2 and a continuous strip of flat paper 4.

The coupling group 40 comprises a gluer, designed, during use, to apply a layer of adhesive substance, for example glue, onto a strip of canneté 2, preferably onto the crests of a strip of canneté 2.

In the embodiment shown in FIG. 2, the gluer comprises a pair of pressure rollers 32 and a gluing roller 34.

According to alternative embodiments, the gluer may also be of the bar type.

According to a particularly advantageous characteristic feature of the present invention, the gluer uses a type of adhesive substance which maintains the adhesive force over time and, even though exposed to atmospheric agents, for example a so-called “open glue” or pressure sensitive adhesive (PSA), able to glue the surfaces of the canneté strip and the flat paper strip when they are pressed together. These types of adhesive substances allow adhesion by means of a physical process and therefore are able to achieve a correct balance between adhesion and cohesion. As regards the compositions of these adhesive substances they may vary depending on the manufacturer: the glues of the PSA type are usually made based on ethylene vinyl acetate (EVA), polyolefins and rubbers.

The coupling group 40 may also comprise so-called “presser group” 30 designed to stabilize the coupling together of a continuous canneté strip and a continuous flat paper strip, and finalize the manufacture of a single-wave corrugated cardboard strip 6.

The presser group 30 may comprise a pair of belts 42, or pressure rollers, designed to press the corrugated cardboard 6, in order to consolidate the gluing together of the sheets which form it. The presser group may also comprise one or more heating plates, which can be selectively activated in order to heat the corrugated cardboard 6 and reduce any moisture which may be present.

According to this embodiment, the presser group forms a pulling system 30 for pulling a strip of canneté 2 and a continuous strip of flat paper 4 by means of a pair of belts 42 or pressure rollers.

This characteristic feature, as will become clearer below, is particularly advantageous in that it allows the structure for storing the canneté strip 2 and the continuous flat paper strip 4 to be greatly simplified.

According to the embodiment shown, the inlet of the presser group 39 faces the gluer.

Obviously, it is possible to envisage embodiments of a coupling group different from that described hitherto without thereby departing from the scope of the present invention.

According to the embodiment shown in the figures, the coupling group 40 is arranged in the lower operating area 28.

The corrugated cardboard production apparatus 10 comprises a store of flat paper 4.

Preferably, the store comprises a reel 60 onto which a continuous strip of flat paper 4 is wound. In the present description, the sheet of flat paper 4 is also referred to as a facing since it forms the sheet of paper which covers a canneté.

The corrugated cardboard production apparatus 10 also comprises a store for canneté 2. Preferably, the store comprises a reel 50 onto which a continuous strip of canneté 2 is wound.

As already mentioned above, the term “canneté” is understood as meaning a sheet of flat paper coupled with a sheet of corrugated paper. The two sheets are preferably glued together. The term “sheet of corrugated paper” is understood as meaning a sheet of flat paper which has undergone a deformation process and which therefore has a plurality of crests alternating with a plurality of grooves. A sheet of corrugated paper is typically produced by a single facer.

According to the embodiment shown in the figures, both the canneté reel 50 and the flat paper reel 60 are arranged vertically offset with respect to the coupling group 40. For example, but not exclusively, both the canneté reel 50 and the flat paper reel 60 are arranged in the upper operating area 26.

According to another particularly advantageous characteristic feature of the present invention, the store of the corrugated cardboard production apparatus 10 does not comprise a suspension device, as is known in the sector, for example a reel holder provided with suspension arms, but comprises a support system 48, 58 for each of the reels 50, 60. With particular reference to the embodiment shown in FIG. 3, the canneté reel 50 is arranged resting on a pair of support rollers 52, 54.

According to this configuration, the support system is arranged underneath the reels 50, 60 and the reels 50, 60 press against the pair of support rollers 52, 54 and are not suspended from suspension arms. This solution simplifies significantly the structure of the apparatus according to the present invention, making it easier to load full reels and unload empty reels from the corrugated cardboard production apparatus.

A first roller is a motorized support roller 54, rotatable about its axis and operationally connected to a first actuator 55 which allows rotation thereof during use.

The motorized support roller 54 is particularly advantageous since rotation thereof may induce, by means of friction, a reduction in the speed of rotation of the canneté reel 50 and therefore unwinding of the strip of canneté 2. Alternatively, rotation of the motorized support 54, in the opposite direction to the preceding direction, may favour the rotation of the canneté reel 50 thereby assisting the pulling force exerted by the pulling system 30. For example, a full reel has a very high weight and therefore, when it passes from a standby position, where the canneté 2 and the flat paper 4 are not being pulled along by the pulling system 30 and the reel is at a standstill, into an operating position, where the canneté 2 and the flat paper 4 are pulled by the pulling system 30, a rotation of the motorized support so as to cause rotation of the reel 50 overcomes the force of inertia and favours unwinding of the canneté and the flat paper 4 from the reel 50, avoiding undesirable tearing. Similarly, when the pulling system 30 interrupts its pulling action, a rotation of the motorized support 54 in the opposite direction to the preceding direction reduces the inertia of the reel 50 and favours the interruption in rotation of the reel 50, preventing the inertia assumed by the reel 50 from causing the unwinding of further quantities of canneté 2 or flat paper 4 which are not being pulled by the pulling system 30.

Again, owing to this solution, it is possible to increase the pulling speed, and therefore unwinding speed, of the canneté 2 and the flat paper 4 in a start & stop mode of the process for producing corrugated cardboard.

Again, in accordance with this second embodiment, a second roller is an idle support roller 52. The idle support roller 52 is particularly useful since the unwinding of the strip of canneté 2 could result in displacement of the canneté reel 50, causing it to slide outside of its seat and compromising correct unwinding of the strip of canneté 2. This function is even more useful when the canneté reel 50 has been almost entirely unwound and its weight is therefore significantly less.

According to a further characteristic feature, the bottom portion of the canneté reel 50 is housed between two side plates 56 which are designed, during use, to limit any oscillations of the reel 50 during unwinding of the strip of canneté 2 and/or keep it aligned with a vertical axis passing through the centre of the said canneté reel 50.

A support system, the same as that described hitherto with reference to the canneté reel 50, is also present for the flat paper reel 60.

According to an advantageous characteristic feature of the present embodiment, the motorized support roller 54 and the idle support roller 542 comprise so-called “no crash” wheels, namely wheels made of a resilient material able to support the canneté reel 50 and, at the same time, able to avoid excessive compression of the canneté 2 itself so as not to modify, for example crush, the crests of the corrugated sheet.

According to one of the possible embodiments of the present invention, the system for supporting the reel 50, 60 may also comprise a brake. For example, as shown in FIG. 3, the support system comprises a braking roller 53 which is selectively movable from a rest position (shown in broken lines) into an operating position in which it is in contact with the motorized support roller 54. The function of the braking roller 53 is to help the motorized support roller 54 in particular to prevent, or slow down, undesirable rotation of the canneté reel or the flat paper reel 60. For example, as mentioned above, in a situation where the motorized support roller 54 is at a standstill, but the canneté reel 50 tends to rotate owing to a force of inertia or a pulling force exerted by the strip of canneté 2, the braking roller 53 in an operating position blocks any rotation of the motorized support roller 54.

Obviously it is possible envisage embodiments of the support system and the brake different from those described and illustrated here. For example, but not exclusively, both the support rollers 52, 54 could be motorized, or both the support rollers 52, 54 could be idle. Similarly, it is possible to envisage a brake on both the support rollers 52, 54 or only on the idle support roller 52.

The corrugated cardboard production apparatus 10 may also comprise a system which constantly detects the tension of the canneté 2 and the flat paper 4 when unwound from the respective reels 50, 60, and a system which constantly imparts a driving force to the motorized support roller 54 even when the weight of the reel is low.

According to the embodiment shown in FIG. 3, the apparatus comprises a jockey wheel 70 for the flat paper store and a jockey wheel for the canneté store. The jockey wheel 70 is a device for controlling the tension of the strip of canneté 2 and the strip of flat paper 4. The jockey wheel 70 has a dual function. The first function is that of imparting a counter-force, which can be adjusted by means of drive belt and which causes braking of the speed of unwinding of the strip of canneté 2 from the canneté reel 50. This force can be adjusted according to predetermined parameters and production requirements. The second function is that of increasing or reducing the speed of unwinding of the strip of canneté 2, depending on the position assumed, so as to keep the tension of the strip of canneté 2 constant.

In other words, the jockey wheel 70 works with a fixed pressure which is determined depending on the tension which is to be imparted to the paper. The position of the jockey wheel 70 determines a correction in the speed of the motorized roller 54 so as to keep the position of the said jockey wheel stable. When the reel 50, 60 starts to lose weight following unwinding of the canneté 2 and the flat paper 4, its weight decreases. In this situation there is the risk that the paper loses its adherence on the motorized roller 54, such that the tension and speed control is no longer effective.

Although the function performed by the jockey wheel 70 is particularly useful for improving the quality of the corrugated cardboard produced and reducing the folds, the jockey wheel 70 is not an essential characteristic feature of the present invention.

Furthermore, it is possible to envisage, if present, also different embodiments of a tension control device.

With the present invention it is possible to provide various embodiments depending on the type of end product to be made, such as single-wave cardboard, several single-wave cardboards but with formats or gramme weights different from each other, or even double-wave cardboard while maintaining the same advantages such as extreme versatility, compact dimensions, greater simplicity and low installation and maintenance costs.

For example, according another embodiment of the present invention shown in FIG. 4, a corrugated cardboard production apparatus comprises two corrugated cardboard production apparatus 10, 10′ arranged side-by-side so as to produce two single-wave corrugated cardboards 6, 6′ with formats and gramme weights different from each other. As shown in FIG. 4, the corrugated cardboard production apparatus 10, 10′ comprise all the characteristic features described hitherto. The first apparatus 10 produces at its output a first single-wave corrugated cardboard 6, while the second apparatus 10′ produces at its output a second single-wave corrugated cardboard 6′.

According to another embodiment of the present invention, not shown, an apparatus for the production of corrugated cardboard comprises a corrugated cardboard production apparatus 10, a second store for canneté strip and an additional coupling group arranged downstream of the coupling group 40 so as to couple, during use, the single-wave cardboard 6 produced by the corrugated cardboard production apparatus 10, together with the canneté strip of the second store.

According to a further embodiment of the present invention it is possible to configure the elements described hitherto so as to reduce further the overall dimensions of a corrugated cardboard production apparatus. As shown in FIG. 5, a corrugated cardboard production apparatus 100 comprises a support structure, for example but not exclusively, a support frame 20. In the embodiment shown in FIG. 5, the support frame 20 extends vertically and comprises at least one pair of lateral uprights 22 and two horizontal surfaces 24, 24′ connected to the lateral uprights 22. The frame shown in FIG. 5 defines three operating areas, i.e. an upper area 25 arranged above a second middle operating area 27, which is in turn arranged above a third operating area 29.

According to possible variants of the present invention, the support frame 20 may also comprise upper and/or lateral covering walls so that the three operating areas 25, 27, 29 form closed compartments.

The corrugated cardboard production apparatus 100 also comprises two coupling groups, generally indicated by the number 40, 40′ and suitable, during use, for composing a single-wave corrugated cardboard 6, 6′ by associating together a strip of canneté 2 and a continuous strip of flat paper 4.

Each coupling group 40, 40′ may comprise a gluer, suitable for applying a layer of adhesive substance, for example glue, onto the strip of canneté 4, preferably onto the crests of a strip of canneté 2, and a presser group 30, 30′, suitable for stabilizing the coupling together of a continuous strip of canneté 2 and a continuous strip of flat paper 4.

As indicated above, each presser group also forms a pulling system 30, 30′ for pulling each strip of canneté 2 and a continuous strip of flat paper 4 by means of the pair of belts 42 or pressure rollers.

According to the embodiment shown in the figures, the two presser groups 30, 30′ are identical to each other, but obviously it is possible to envisage embodiments with presser groups different from each other and technically equivalent to those described here.

For the sake of brevity, the description of the coupling groups 40, 40′, the gluer and the adhesive substances and of the presser groups, provided above with reference to the embodiment of FIGS. 1 to 4, is incorporated here by way of reference.

Obviously it is possible to envisage embodiments of coupling groups different from those described here.

According to the embodiment shown in FIG. 5, the inlet of each presser group 30, 30′ faces a respective gluer.

According to the embodiment shown in FIG. 5, both the coupling groups 40, 40′ are arranged in the lower operating area 29. One of the coupling groups 40 is arranged vertically offset with respect to the other coupling group 40′. Owing to this configuration it is possible to reduce the overall dimensions of the corrugated cardboard production apparatus, while producing two single-wave corrugated cardboards 6, 6′, for example, but not exclusively, with formats or gramme weights different from each other.

The corrugated cardboard production apparatus 10 comprises a first canneté store.

Preferably, the first store comprises a reel 50 onto which a continuous strip of canneté 2 is wound. The corrugated cardboard production apparatus 10 comprises a second store for the flat paper 4. Preferably, the second store comprises a reel 60 onto which a continuous strip of flat paper 4 is wound.

According to the embodiment shown in FIG. 5, both the canneté reel 50 and the flat paper reel 60 are arranged above the coupling groups 40, 40′. For example, both the canneté reel 50 and the flat paper reel 60 are arranged in the middle operating area 27.

The corrugated cardboard production apparatus 10 also comprises a system for supporting the reels 50, 60, and a jockey wheel 70. For the sake of brevity, the description of the support system for the reels 50, 60 and the jockey wheel 70, provided above with reference to the embodiment of FIGS. 1 to 4, is incorporated here by way of reference.

The corrugated cardboard production apparatus 10 also comprises a second canneté store. Preferably, the second canneté store comprises a reel 150 onto which a continuous strip of canneté 2 is wound. The corrugated cardboard production apparatus 10 also comprises a second store of flat paper 4. Preferably, the second flat paper store comprises a reel 160 onto which a continuous strip of flat paper 4 is wound.

The corrugated cardboard production apparatus 10 also comprises a further support system for each of the reels 150, 160, and a respective jockey wheel 170. For the sake of brevity, the description of the support system for the reels 150, 160 and the jockey wheel 170, provided above with reference to the embodiment of FIGS. 1 to 4, is incorporated here by way of reference.

According to the embodiment shown in the figures, both the canneté reel 150 and the flat paper reel 160 are arranged above the canneté strip reel 50 and the flat paper strip reel 60. For example, both the canneté reel 150 and the flat paper reel 160 are arranged in the upper operating area 25.

According to the configuration of the corrugated cardboard production apparatus 10 shown in FIG. 5, the strip of canneté 2 of the reel 150 of the second store and the strip of flat paper 4 of the reel 160 are inserted inside the first coupling group 40′ so as to form a first single-wave corrugated cardboard 6′, while the strip of canneté 2 of the reel 50 of the first store and the strip of flat paper 4 of the reel 60 are inserted inside the second coupling group 40 so as to form a second single-wave corrugated cardboard 6.

During use, with any of the embodiments described above, the apparatus according to the present invention is used for the production of cardboard “on demand”, namely for the production of cardboard with predetermined dimensions so as to able to provide containers, for example boxes, with predetermined dimensions, wherein these dimensions are in each case modified as required, namely “on demand”. For this reason, and differently from the cardboard production plants of the known type, the apparatus must be able to operate in “start & stop” mode, namely start so as to produce a first required cardboard, stop pending a new request, and start again so as to produce a second required cardboard.

The method for the production of cardboard “on demand” therefore comprises the following steps:
providing a coupling group 40, a flat paper reel 60, a canneté reel 50 and a system for supporting the reels 50, 60 comprising a pair of support rollers 52, 54;
starting the unwinding of a strip of flat paper 4 and a strip of canneté 2 from the reels 50, 60;
transferring the strip of flat paper 4 and the strip of canneté 2 unwound from the reels 50, 60 to the coupling group 40;
coupling together the strip of flat paper 4 and the strip of canneté 2 so as to form a single-wave corrugated cardboard 6, 6′; and
interrupting the unwinding of the strip of flat paper 4 and the strip of canneté 2 from the reels 50, 60

According to a further embodiment, the method also comprises the steps of:
providing a pulling system 30; and
pulling the strip of flat paper 4 and the strip of canneté 2 towards the coupling group 40, unwinding them from the reels 50, 60.

According to a particularly advantageous characteristic feature, the method also comprises the step of applying a layer of adhesive substance onto the strip of canneté 2 before coupling it together with the strip of flat paper 4.

According to a further embodiment of the present invention, the method may comprise, after the step of interrupting the unwinding of the strip of flat paper 4 and the strip of canneté 2 from the reels 50, 60, a step of activating the motorized support roller in order to counteract rotation of the reel 50, 60.

According to this embodiment, the method may comprise, before the step of starting unwinding of the strip of flat paper 4 and the strip of canneté 2 from the reels 50, 60, a step of activating the motorized support roller in order to favour rotation of the reel 50,60.

1. A corrugated cardboard production apparatus, comprising:
a coupling group suitable for composing a single-wave corrugated cardboard by associating together a strip of canneté and a continuous strip of flat paper; and
a flat paper store and a canneté store;
wherein the flat paper store and the canneté store are reels, and
wherein the apparatus further comprises a support system for the reels comprising a pair of support rollers.

2. The apparatus of claim 1, wherein the coupling group comprises a pulling system for pulling the strip of canneté and the continuous strip of flat paper, unwinding the strip of canneté and the continuous strip of flat paper from respective reels.

3. The apparatus of claim 1, wherein the support system is underneath the reels, and
wherein the reels are on the pair of support rollers.

4. The apparatus of claim 1, wherein the flat paper store and the canneté store are vertically offset with respect to the coupling group.

5. The apparatus of claim 4, further comprising:
a support structure defining an upper operating area and a lower operating area;
wherein the flat paper store and the canneté store are in the upper operating area, and
wherein the coupling group is in the lower operating area.

6. The apparatus of claim 1, wherein the coupling group comprises a gluer.

7. The apparatus of claim 1, wherein at least one of the pair of support rollers is a motorized support roller.

8. The apparatus of claim 7, wherein the support system comprises a brake.

9. A method for production of cardboard “on demand”, the method comprising:
providing a coupling group, a flat paper reel, a canneté reel, and a system for supporting the reels that comprises a pair of support rollers;
starting an unwinding of a strip of flat paper and a strip of canneté from respective reels;
transferring the strip of flat paper and the strip of canneté, unwound from the respective reels, to the coupling group;
coupling together the strip of flat paper and the strip of canneté so as to form a single-wave corrugated cardboard; and
interrupting the unwinding of the strip of flat paper and the strip of canneté from the respective reels.

10. The method of claim 9, further comprising:
applying a layer of adhesive substance of a pressure-sensitive-adhesive type onto the strip of canneté.

11. A corrugated cardboard production apparatus, comprising:
a coupling group configured to associate a strip of canneté and a continuous strip of flat paper to form single-wave corrugated cardboard;
a first reel to store the canneté;
a second reel to store the flat paper;
first rollers to support the first reel; and
second rollers to support the second reel.

12. The apparatus of claim 11, wherein the coupling group comprises a system configured to pull the strip of canneté from the first reel and to pull the continuous strip of flat paper from the second reel.

13. The apparatus of claim 11, wherein the coupling group comprises a system configured to unwind the strip of canneté from the first reel and to unwind the continuous strip of flat paper from the second reel.

14. The apparatus of claim 11, wherein the first and second reels are vertically offset with respect to the coupling group.

15. The apparatus of claim 11, wherein the first reel is horizontally offset with respect to the second reel.

16. The apparatus of claim 11, wherein the coupling group comprises a gluer.

17. The apparatus of claim 11, wherein at least one of the first rollers is motorized.

18. The apparatus of claim 11, wherein at least one of the second rollers is motorized.

19. The apparatus of claim 11, further comprising:
a brake associated with the first rollers.

20. The apparatus of claim 11, further comprising:
a brake associated with the second rollers.
